(19) United States
(12) Patent Application Publication
(10) Pub. No.: US 2010/0129280 A1
(43) Pub. Date: May 27, 2010

(54) BiMO PARTICLE MANUFACTURING METHOD AND PHOTOCONDUCTIVE LAYER

(75) Inventors: Hiroyuki HIRAI, Ashigarakami-gun (JP); Yoshiko NIINO, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/626,429

(22) Filed: Nov. 25, 2009

(30) Foreign Application Priority Data
Nov. 27, 2008 (JP) 2008-302165
Mar. 11, 2009 (JP) 2009-058423

(51) Int. Cl. C01B 33/20; C01G 23/00; C01G 29/00

(52) U.S. Cl. 423/326; 423/598; 423/594.7

(57) ABSTRACT

A method for manufacturing a BiMO particle (M is either one of Si, Ge, Ti, and Sn), in which at least one type of compound selected from the group consisting of a silicon compound, a germanium compound, a titanium compound, and a tin compound is reacted with a bismuth compound by agitating and mixing the compounds in an alkali water solution in the presence of an amino compound.

### BACKGROUND OF THE INVENTION

1. Field of the Invention

The present invention relates to a method for manufacturing a BiMO particle and a photoconductive layer constituting a radiation imaging panel and employing a particle manufactured by the method.

2. Description of the Related Art

Use of particles formed of Bi, M, and O elements (Hereinafter, “BiMO particles”), such as Bi₁₂SiO₂₀, Bi₁₂GeO₂₀, Bi₁₂TiO₂₀, Bi₄Ge₃O₁₂, Bi₄Ti₃O₁₂, Bi₂Ti₇O₇, and the like in electro-photographic materials, X-ray detection materials, ceramic condensers, and the like has been considered as they have photoconductivity and dielectricity. When a ceramic formed of BiMO is used in such applications, the BiMO particles, the material of the ceramic, are conventionally manufactured by solid phase method in which individual oxides of constituent elements are mixed and baked as described, for example, in “Processing and Dielectric Properties of Sillenite Compounds Bi₁₂MO_{20-δ}(M=Si, Ge, Ti, Pb, Mn, B_{1/2}P_{1/2})”, M. Valant and D. Suvorov, J. Am. Ceram. Soc., Vol. 84, No. 12, pp. 2900-2904, 2001 (Non-Patent Document 1).

The solid phase method, however, does not produce particles having uniform a composition, or a shape and size, so that there is a limit on producing a uniform and dense compact or a good ceramic. Further, the solid phase method essentially requires a crushing and mixing process and mixing of impurity from a vessel during the process is inevitable, causing a problem that a finished product does not have satisfactory performance.

In contrast to the solid phase method, a liquid phase method is also known for manufacturing BiMO particles. For example, in “SOLUTION SYNTHESIS AND CHARACTERIZATION OF SILLENITE PHASES, Bi₂₄M₂O₄₀(M=Si, Ge, V, As, P)”, H. S. Horowitz et al., Solid State Ionics, Vol. 32/33, pp. 678-690, 1989 (Non-Patent Document 2) describes a method in which Bi (NO₃)₃ and Na₂O.xSiO₂, as Si source, or GeO₂, as Ge source, are dissolved in an acid, which are then deposited by adding an alkali metal hydroxide, and Bi₁₂MO₂₀ is combined by setting the temperature to an appropriate value after pH preparation.

The particle diameter of Bi₁₂MO₂₀ powder manufactured by the method described in Non-Patent Document 2 is as large as about 10 μm which prevents the manufacture of a precise compact or a high density ceramic. For example, a photoconductive layer formed of Bi₁₂MO₂₀ powder having such a large particle diameter poses a problem that the collection efficiency of generated charges is poor due to a low filling density.

In order to solve the problem, Japanese Unexamined Patent Publication Nos. 2006-248820 (Patent Document 1) and 2007-063100 (Patent Document 2) describe a method for manufacturing Bi₁₂MO₂₀ powder having a small particle diameter based on the liquid phase method, and a photoconductive layer constituting a radiation imaging panel and employing the Bi₁₂MO₂₀ powder.

Bismuth compounds, such as bismuth nitrate, bismuth trichloride, bismuth oxide, and the like used in Non-Patent Document 2, Patent Document 1, and Patent Document 2 are water-soluble only under strong acid conditions and a hardly-soluble bismuth oxy compound is likely to be formed by hydrolysis. It has been found that these cause a problem that the shape and composition of Bi₁₂MO₂₀ particles that can be obtained are changeable and a metallic impurity is likely to be mixed in from a reaction vessel.

In particular, a general stainless reaction vessel and an agitating blade used for high density mass production are not usable due to corrosion by strong acid such as nitric acid. Therefore, they require coating with a material having a high acid tolerance, such as Teflon® or the like, or an expensive titanium vessel needs to be used instead of the stainless vessel. This results in an increased equipment cost, causing a major obstacle to the appropriateness of manufacturing.

The present invention has been developed in view of the circumstances described above, and it is an object of the invention to provide a method for manufacturing a high density BiMO particle having a stable shape and composition without using a strong acid, and a photoconductive layer constituting a radiation imaging panel and employing the BiMO particle.

### SUMMARY OF THE INVENTION

A method of the present invention is a method for manufacturing a BiMO particle (M is either one of Si, Ge, Ti, and Sn, hereinafter omitted), wherein at least one type of compound selected from the group consisting of a silicon compound, a germanium compound, a titanium compound, and a tin compound is reacted with a bismuth compound by agitating and mixing the compounds in an alkali water solution in the presence of an amino compound.

Preferably, the amino compound is a water-soluble aliphatic amino compound, and more preferably the aliphatic amino compound is an alkanolamine. Preferably, the alkali water solution further includes a multivalent organic acid or a salt thereof. Preferably, the bismuth compound is a multivalent organic acid bismuth compound.

Preferably, the silicon compound is an alkali metal, quaternary ammonium silicate, or a tetraalkoxysilane. Preferably, the germanium compound is a germanium oxide (IV) or a germanium tetraalkoxide. Preferably, the titanium compound is a titanium chloride (IV) or a titanium (IV) tetraalkoxide. Preferably, the tin compound is a tin chloride or a tin (IV) tetraalkoxide.

Preferably, the alkali water solution is at least one water solution selected from the group consisting of an alkali metal hydroxide, an NR₄OH (R is an alkyl group with a carbon number 1 to 4), an amidine, and a guanidine. Preferably, the temperature of the reaction is in the range from 40° C. to a boiling point of the alkali water solution. Preferably, a BiMO particle manufactured by the method described above is further baked at a temperature in the range from 400 to 700° C.

A photoconductive layer of the present invention is a layer constituting a radiation imaging panel for recording radiation image information as an electrostatic latent image, wherein the photoconductive layer is a layer manufactured by using a BiMO particle obtained by the manufacturing method of the present invention.

In the method for manufacturing a BiMO particle of the present invention, at least one type of compound selected from the group consisting of a silicon compound, a germanium compound, a titanium compound, and a tin compound is reacted with a bismuth compound by agitating and mixing the compounds in an alkali water solution in the presence of an amino compound. This enables the acquisition of a particle that includes less impurity in comparison with a particle manufactured by the solid phase method or any known liquid phase method using a strong acid. Further, implementation of the dissolution operation in the presence of amino compound allows the preparation of a high concentration solution of water-soluble bismuth salt, so that high density BiMO particles having a stable shape and composition may be manufactured.

Further, the manufacturing method of the present invention allows the use of an inexpensive stainless steel vessel, which has been difficult in the past due to the problem of impurities, because a strong acid is not required any more resulting in a remarkable reduction in the manufacturing costs. In addition, the avoidance of impurities may improve the quality, whereby particles having a remarkably stable particle size, shape, and composition may be obtained.

Then, a photoconductive layer manufactured by using such pure and uniform BiMO particles may have high collection efficiency of generated charges and reduced electrical noise, resulting in improved granularity of an image and increased sensitivity.

### BRIEF DESCRIPTION OF THE DRAWINGS

Figure illustrates an XRD pattern of a Bi₁₂SiO₂₀ particle obtained by a manufacturing method of the present invention.

### DESCRIPTION OF THE PREFERRED EMBODIMENTS

A method for manufacturing a BiMO particle of the present invention is a method in which at least one type of compound selected from the group consisting of a silicon compound, a germanium compound, a titanium compound, and a tin compound is reacted with a bismuth compound by agitating and mixing the compounds in an alkali water solution in the presence of an amino compound.

Preferably, the bismuth compound used in the present invention is a trivalent compound, and bismuth nitrate, bismuth chloride, bismuth bromide, bismuth oxide, bismuth (III) alkoxide (e.g., bismuth (III) ethoxide, or bismuth (III) isopropoxide), organic acid bismuth, or the like may be used. Among these, the organic acid bismuth is more preferably used in order to avoid incorporation of inorganic anions which are likely to become impurities.

Organic acids forming organic acid bismuth compounds include monocarbonic acids, such as formic acid, acetic acid, propionic acid, butyric acid, and the like, multivalent organic acids, such as oxalic acid, citric acid, acidum tartaricum, malonic acid, succinic acid, tricarballylic acid, and the like, and aliphatic amino acids, such as glycine, alanine, valine, serine, threonine, lysine arginine, asparagine acid, glutamic acid, β-aminopropionic acid, and the like. Preferably, the organic acids are soluble in water. Multivalent organic acids capable of forming soluble bismuth compounds are particularly preferable. Among them, citric acid bismuth (III) is best suited.

In the method for manufacturing a BiMO particle of the present invention, the reaction takes place in the presence of an amino compound in order to prepare a high density solution of water-soluble bismuth salt. As for the amino compound, an aliphatic amino compound, such as highly water-soluble alkanolamine having a boiling point not less than 100° C., ethylenediamine, 1,3-diaminopropane, 1,4-diaminobutane, diacetoneamine, diethylene triamine, tetramethylethylenediamine, hexamethylenetetramine, amidine, guanidine, or the like, is preferably used. Amidine or guanidine has a strong basicity so that it may also be used as alkali to be described later.

Among the aliphatic amino compounds, alkanolamines, such as monoethanolamine, diethanolamine, triethanolamine, 2-diethylaminoethanol, 2-amino-2-methyl-1-propanol, and the like are more preferably used. In particular, the triethanolamine is more preferable because it is capable of forming a stable chelate with Bi(III) ions.

The water-soluble bismuth salt solution may be prepared by mixing the organic acid bismuth compound described above with an amino compound and dissolving the mixture in water or by mixing another bismuth compound with an amino compound or an organic acid (or salt of the organic acid) and an amino compound, and dissolving the mixture in water. The organic acid may be selected from the compounds described above, and a multivalent organic acid capable of easily dissolving a bismuth compound is particularly preferable. Preferably, the molar ratio of the amino compound to the bismuth compound is from 1 to 10, more preferably from 1 to 5, and further preferably from 1.5 to 3. Molar ratios smaller than 1 and greater than 10 are not desirable, because a molar ratio smaller than 1 reduces the dissolved concentration of the bismuth compound, while a molar ratio greater than 10 reduces the particle formation speed. Also, preferably, the molar ratio of the amino compound to the organic acid is from 1 to 10, more preferably from 1 to 5, and further preferably from 1.5 to 3.

As for the silicon compound, alkali metals, such as liquid glass, potassium silicate, tetramethylammonium silicate, and the like, quaternary ammonium silicates, or tetraalkoxysilanes, such as tetraethoxysilane, tetramethoxysilane, tetraisopropoxysilane, and the like are preferably used.

As for the germanium compound, germanium (IV) tetraalkoxides, such as germanium oxide (IV), germanium (IV) ethoxide, germanium (IV) isopropoxide, and the like are preferably used.

As for the titanium compound, titanium (IV) tetraalkoxides, such as titanium chloride (IV), titanium (IV) ethoxide, titanium (IV) isopropoxide, and the like are preferably used.

As for the tin compound, tin (IV) tetraalkoxides, such as tin chloride (IV), tin (IV) ethoxide, tin (IV) isopropoxide, tin (IV)-t-butoxide, and the like are preferably used.

Preferably, the alkali water solution is at least one water solution selected from the group consisting of an alkali metal hydroxide (LiOH, NaOH, KOH, RbOH, CsOH), an NR₄OH (R is an alkyl group with a carbon number 1 to 4), an amidine, and an guanidine. In particular, NR₄OH, such as tetramethylammonium hydroxide, tetraethylammonium hydroxide, or the like is more preferable because it is stable in a water solution and does not cause the alkali metal to remain on particles of the present invention and intended photoconductivity is not degraded. Preferably, the alkali concentration of the reaction solution is from pH9 to 14, more preferably from pH10 to 14, and particularly preferable from pH 11 to 14 from the viewpoint that precise crystals can be obtained.

In the present invention, various types of organic compounds may be added to the reaction solution in order to control the size and shape of particles. High-molecular compounds are preferably used since they have advantageous effects for controlling the size and shape of the particles, in particular, hydroxyethyl cellulose and hydroxypropyl cellulose are preferable. The hydroxyethyl cellulose and hydroxypropyl cellulose may be used individually or mixed together appropriately. The amount of hydroxyethyl cellulose and hydroxypropyl cellulose used depends on the reaction temperature, capacity of the reaction container, volume of the alkali water solution, and the like. It is preferable, however, that an amount of 5 to 50 mass % per unit mass of particles to be produced is used from the viewpoints of reaction efficiency and economy. It is also preferable that the molecular weight of the hydroxyethyl cellulose and hydroxypropyl cellulose used is in the range from 10,000 to 500,000.

In the present embodiment, various types of hydrophilic organic solvents may be added to the reaction solution in order to control the reaction temperature and improve the solubility of reactive species, such as the bismuth compound, silicon compound, and the like. As for the hydrophilic organic solvents, various compounds may be used. For example, methanol, ethanol, 2-ethoxyethanol, tetrahydrofuran, N,N-dimethylformamide, ethylene glycol, diethylene glycol, triethylene glycol, propylene glycol, glycerin, dioxane, and the like are preferably cited.

Preferably, the reaction temperature is in the range from 40° C. to a boiling point of the alkali water solution (reaction solution containing at least one type of compound selected from the group consisting of silicon compound, germanium compound, titanium compound, and tin compound, a bismuth compound, and an amino compound), more preferably in the range from 50 to 100° C., and further preferably in the range from 60 to 90° C. Below 40° C., the crystallization speed is slow and nonproductive. The reaction time varies with the reaction temperature and may be set arbitrarily. It is, for example, from 10 minutes to 3 days, more preferably, from 20 minutes to 20 hours, and further preferably from 30 minutes to 10 hours. As for the heating means, a microwave or an autoclave may be used other than the ordinary hot water or oil bath.

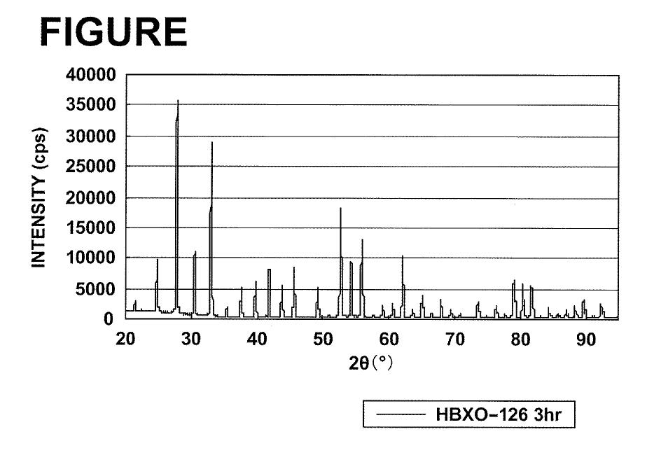

The particles of the present invention may be formed by various methods. The simplest method is to react at least one type of compound selected from the group consisting of silicon compound, germanium compound, titanium compound, and tin compound with a bismuth compound by agitating and mixing them in an alkali water solution in the presence of an amino compound and at the same time increasing the temperature of the solution to a predetermined value. Another method is to produce the particles by adding a mixed solution of at least one type of compound selected from the group consisting of silicon compound, germanium compound, titanium compound, and tin compound, a bismuth compound, and an amino compound to an alkali mother liquor (alkali water solution) having a predetermined temperature while agitating the mother liquor. Still another method is to produce the particles by heating a mixed solution of at least one type of compound selected from the group consisting of silicon compound, germanium compound, titanium compound, and tin compound, a bismuth compound, and an amino compound to a predetermined temperature and adding an alkali water solution to the mixed solution. As for the reaction device, a reaction device shown in FIG. 1 of Patent Document 1 may be cited.

The BiMO particle manufacturing method of the present invention can be applied to compounds having various atomic ratios, as described above, but a particularly preferable composition as a photoconductor (photoconductive layer) is Bi₁₂MO₂₀. Preferably, in this case, M is Si or Ge. But, it is not necessarily to be strict to the atomic ratio described above and may vary within about 10%. Further, M may be a single element or a compound of two or more elements (e.g., Si with Ge, Si with Ti, Ge with Sn, and the like).

Through decantation of the dispersed materials (dispersed solution) obtained by the reaction or removal of the liquid component by vacuum filtration or centrifuge method, intended particles may be obtained. The particles obtained at this stage are coarse particles, including a by-product. It is, therefore, preferable to refine them by washing with water, alcohol, or the like.

Preferably, the particles are baked at a temperature below the sintering temperature of the particles, more preferably at a temperature in the range from 400 to 700° C., and further preferably at a temperature in the range from 450 to 650° C. in order to remove an organic substance and facilitate crystallization. A low baking temperature below 400° C. does not sufficiently promote decomposition of the organic substance or causes insufficient desorption of the adsorbed water, thereby posing problems of degraded sensitivity and large dark current when a photoconductive layer, to be described later, is formed. On the other hand, it has been found that a high temperature over 700° C. causes sintering more readily to occur, thereby making the manufacture of an uniform photoconductive layer difficult. The baking time depends on the baking temperature, particle size, particle composition, amount of residual organic substances, so that the time may set appropriately in a wide range.

Preferably, an inorganic content other than the constituent elements in each BiMO particle obtained by the manufacturing method described above is not greater than 100 ppm, and more preferably not greater than 10 ppm. A content of impurity inorganic ion greater than 100 ppm is undesirable, because it causes a large dark current when the particles are used as a photoconductive layer to be described later. Such inorganic ions are caused by various types of raw materials and materials of the production container and solution sending system. For example, as for cations, alkali metal ions such as Li⁺, Na⁺, K⁺, and the like, and alkali earth metal ions, such as Ca²⁺, Mg²⁺, and the like may be pointed out. As for anions, nitrate ion, sulfate ion, chloride ion, bromide ion, and the like may be pointed out.

As for the specific method for manufacturing a photoconductive layer using the obtained particles, for example, the following known methods may be used. Namely, an aerosol deposition method in which Bi₁₂MO₂₀ particles are thrown up in vacuum by a carrier gas and the carrier gas mixed with the particles is blown to a support to deposit the Bi₁₂MO₂₀ particles on the support. A press sintering process in which Bi₁₂MO₂₀ particles are formed into a film under a high pressure by a uniaxial pressing machine or a cold isostatic pressing machine, and then the film is sintered at a high temperature. A hot isostatic pressing process in which Bi₁₂MO₂₀ particles are processed by applying a high temperature of several 100° C. and an isostatic pressure of several 10 to several 100 MPa at the same time. A method in which Bi₁₂MO₂₀ particles are applied using a binder to produce a green sheet (film with the binder), and the green sheet is baked for desorption of the binder and sintering of the particles (hereinafter, “green sheet method”). Here, the description has been made of a case in which Bi₁₂MO₂₀ particles having a desirable composition are described, but the methods described above may also be applied to BiMO particles other than the Bi₁₂MO₂₀ particles.

As for the binder used in the green sheet method, the following is preferably used, namely cellulose nitrate, hydroxypropyl cellulose, ethyl cellulose, hydroxyethyl cellulose, cellulose acetate, vinylidene chloride•vinyl chloride copolymer, polyalkyl methacrylate, polyurethane, polyvinyl butyral, polyester, polyslylene, polyamide, polyethylene, polyvinyl chloride, polyvinyl acetate, vinyl chloride•vinyl acetate copolymer, cellulose acetate, polyvinyl alcohol, linear polyester, and the like.

Another method that can be used for manufacturing a photoconductive layer using the obtained particles is to disperse the Bi₁₂MO₂₀ particles in a binder and apply the solution to a provisional support by any known coating method, such as dip method, spray coating method, or the like. As for the binder for the coating method, the binders for the green sheet method may be used.

A radiation imaging panel having a photoconductive layer produced by using the particles of the present invention will now be described. Two types of radiation imaging panels are available. One of which is a direct conversion type in which radiation is directly converted to charges and stored, and the other of which is an indirect conversion type in which radiation is first converted to light by a scintillator, such as CsI, and then the light is converted to charges by an amorphous-Si photodiode. The photoconductive layer produced by using the particles of the present invention may be used in the former direct conversion type. As for the radiation, y rays and a rays may be used other than X rays.

Further, the photoconductive layer produced by using the particles of the present invention may be used for the following two readout types, one of which is a so-called an optical readout type in which image reading is performed using a radiation image detector of a semiconductor material that generates charges when exposed to light, and other of which is a method in which charges generated by the emission of radiation are stored and the stored charges are read out by ON/OFF switching an electric switch, such as a thin film transistor (TFT) or the like, with respect to each pixel (hereinafter, “TFT readout type”).

An example of the former optical readout type radiation imaging panel is like that shown in FIG. 2 of Patent Document 1. The photoconductive layer produced by using the particles of the present invention may be used for recording radiation conductive layer 22 shown in FIG. 2. That is, the photoconductive layer produced by using BiMO particles obtained by the manufacturing method of the present invention is a recording radiation conductive layer. An example of the latter TFT readout type radiation imaging panel is like that shown in FIG. 7 of Patent Document 1. The photoconductive layer produced by using the particles of the present invention may be used for recording radiation conductive layer 104 shown in FIG. 7.

The recording process of an electrostatic latent image, radiation detector (detecting unit), active matrix substrate (AMA substrate), and the like are described in detail in Patent Document 1, and are applicable to the photoconductive layer of the present invention. Hereinafter, examples of BiMO particle manufacturing method of the present invention and example products of the photoconductive layer constituting a radiation imaging panel will be described.

### Example 1

47.8 g of bismuth citrate (99.99% purity) and 35.8 g of triethanolamine were dissolved in 360 ml of water. Then, 2.4 ml of potassium silicate solution (28%) and 200 ml of 4N—KOH solution were added to the water solution. The resultant solution had a pH of 13.7. The solution was then poured into reaction vessel 2 (stainless steel) of manufacturing equipment 1 having an agitator 1 shown in FIG. 1 of Patent Document 1. Solution sending tanks 4 and 5 were not used. Reaction vessel 2 was heated by jacket 3 to raise the temperature to 40° C. The rotational speed of motor 9 is set to 800r/min and the reaction solution was agitated by agitator 8. The solution was heated to 90° C. and the agitation was continued for 5 hours, and then cooled to normal temperature. The white sediment obtained was filtered and refined. Particles obtained by drying the sediment were measured by X-ray diffraction method (XRD) and Bi₁₂SiO₂₀ crystals with Sillenite structure were obtained as illustrated in Figure. Composition analysis performed by inductively-coupled plasma optical emission spectrometry (ICP) showed that the Bi/Si atomic ratio was 11.9. Further, from an SEM image obtained by the observation of the particles with a scanning electron microscope (SEM), the average particle diameter was obtained on the assumption that each particle has a circular shape having the same area. The result showed that the particles are cubic particles with an average particle diameter of 2 μm and a coefficient of variation of 16%. The coefficient of variation is a value obtained by dividing the standard deviation of the particle size by the average value and expressed in percentage.

### Example 2

Particles having Bi₁₂SiO₂₀ crystal structure with an average particle diameter of 8 μm and a coefficient of variation of 18% were obtained in a manner similar to that of Example 1, except that the triethanolamine was substituted with equimolar diethanolamine.

### Example 3

Particles having Bi₁₂SiO₂₀ crystal structure with an average particle diameter of 8 μm and a coefficient of variation of 19% were obtained in a manner similar to that of Example 1, except that the triethanolamine was substituted with equimolar 2-diethylaminoethanol.

### Example 4

Particles having Bi₁₂SiO₂₀ crystal structure with an average particle diameter of 8 μm and a coefficient of variation of 19% were obtained in a manner similar to that of Example 1, except that the 4N—KOH was substituted with equimolar tetramethylammonium hydroxide solution.

### Example 5

Particles were obtained in a manner similar to that of Example 1, except that potassium silicate solution was substituted with equimolar germanium isopropoxide and reaction temperature was set to 80° C. XRD measurement of the particles showed that Bi₁₂SiO₂₀ crystal structure was obtained. Composition analysis by ICP showed that the Bi/Ge atomic ratio was 12.1. Further, SEM observation showed that the particles are cubic particles with an average particle diameter of about 3 μm and a coefficient of variation of 16%.

### Example 6

10 ml of ethanol, 10 ml of acetic acid, and 37 ml of water were added to 2.5 ml of tetraethoxy orthosilane (TEOS) to prepare a TEOS solution. 47.8 g of bismuth citrate (99.99% purity) and 28.0 g of tetramethylethylenediamine were dissolved in 360 ml of water, and 42 ml of the TEOS solution was added to the water solution to prepare mother liquor. The mother liquor was poured into reaction vessel 2 of manufacturing equipment 1 having an agitator shown in FIG. 1 of Patent Document 1, and 100 ml of 8N—KOH solution was poured into solution sending tank 4. Solution sending tank 5 was not used. The reaction vessel and solution sending tank were made of stainless steel. The reaction vessel 2 was heated by jacket 3 to raise the temperature of the mother liquor to 85° C. The rotational speed of motor 9 is set to 800 r/min and the mother liquor was agitated by agitator 8. While keeping this state, 8N—KOH solution was added from solution sending tank 4 to reaction vessel 2 at a rate of 4 ml/min and the resultant solution was heated and agitated for 5 hours. After the solution was cooled to room temperature, the white sediment obtained was centrifuged and refined. ICP composition analysis, as in Example 1, showed that the Bi/Si atomic ratio was 11.7. Further,

XRD measurement of the powder showed that the crystal structure was the intended Bi₁₂SiO₂₀ crystal structure. Further, SEM observation showed that the particles obtained were those of about 5 μm with a coefficient of variation of 17%.

### Example 7

Particles were obtained in a manner similar to that of Example 1 except for the following. 2.28 g of titanium tetraisopropoxide and 2.38 g of triethanolamine were mixed. Then 76 ml of water was added to the mixture and heated for 24 hours at 100° C. 38.2 g of bismuth citrate (99.99% purity) and 38.6 g of triethanolamine were dissolved in 280 ml of water. Then the entire titanium tetraisopropoxide solution and 80 ml of 4N—KOH were added to the water solution to prepare the reaction solution. Particles obtained by drying the sediment were subjected to XRD analysis, which showed that Bi₁₂SiO₂₀ crystal structure was obtained. ICP composition analysis showed that the Bi/Ti atomic ratio was 11.6. Further, SEM observation showed that the particles obtained were those of about 2 μm with a coefficient of variation of 20%.

### Example 8

Particles having Bi₁₂SnO₂₀ crystal structure with an average particle diameter of 4 μm and a coefficient of variation of 18% were obtained in a manner similar to that of Example 7, except that titanium tetraisopropoxide were substituted with equimolar tin-t-butoxide.

### Example 9

Particles were obtained in a similar manner to that of Example 1, except that 60% of the potassium silicate solution was substituted with equimolar germanium isopropoxide and the reaction temperature was set to 80° C. XRD analysis of the particles obtained showed that Sillenite structure was obtained. ICP composition analysis showed that the Bi/Ge atomic ratio was 19.6, and Bi/Si atomic ratio was 30.2. Further, SEM observation showed that the particles obtained were those with an average particle diameter of about 3 μm with a coefficient of variation of 19%.

### Example 10

Particles were obtained in a manner similar to that of Example 1, except that the reaction solution was prepared by dissolving 32 g of bismuth citrate (99.99% purity) and 24 g of triethanolamine in 360 ml of water and adding 18.6 ml of germanium isopropoxide and 200 ml of 4N—KOH solution to the water solution, and the reaction conditions of 5 hours at 80° C. Particles obtained by drying the sediment were subjected to composition analysis, which showed that Bi/Ge atomic ratio was 1.30 (Bi₄Ge₃O₁₂ crystal structure). Further, SEM observation showed that the particles obtained were those with an average particle diameter of about 4 μm and a coefficient of variation of 19%.

### Comparative Example 1

48.2 g of bismuth nitrate•pentahydrate (99.9% purity) was dissolved in 80 ml of 1N nitric acid aqueous solution and water is added to prepare 100 ml of additive solution “a”. Separately, 100 ml of additive solution “b” was prepared by dissolving 1.29 g of potassium metasilicic acid and 32.5 g of potassium hydroxide in water. Further, 500 ml of mother liquor P was prepared by dissolving 0.77 g of potassium metasilicic acid and 28.1 g of potassium hydroxide in 450 ml of water and further adding water. Mother liquor P was poured into reaction vessel 2 of manufacturing equipment 1 having an agitator shown in FIG. 1 of Patent Document 1. Additive solutions “a” and “b” were poured into solution sending tanks 4 and 5 respectively. The reaction vessel and solution sending tanks used were those made of stainless steel. Mother liquor P was heated by jacket 3 to raise the temperature to 40° C. The rotational speed of motor 9 is set to 800 r/min and mother liquor P was agitated by agitator 8. While keeping this state, additive solutions “a” and “b” were added to reaction vessel 2 from solution sending tanks 4 and 5 respectively at a rate of 20 ml/min. After the addition of the additive solutions “a” and “b”, the pH of the resultant solution was adjusted to 14. Then the resultant solution was heated to 75° C. and agitated for 2 days, and then cooled to normal temperature to filter faint yellow dispersed material. After the filtration, the material was washed three times with potassium hydroxide solution (0.1N), then washed several times with water, and finally subjected to ethanol rinse, whereby particles having Bi₁₂SiO₂₀ crystal structure were obtained.

### Comparative Example 2

Particles having Bi₁₂SiO₂₀ crystal structure were obtained in a manner similar to that of Comparative Example 1, except for the following. 50 ml of additive solution “b” was prepared by adding methanol to 2.36 g of titanium tetraisopropoxide. 550 ml of mother liquor P was prepared by dissolving 60.6 g of potassium hydroxide in water. Then mother liquor P was poured into reaction vessel 2 and while liquor P was agitated, additive solutions “a” and “b” were added to reaction vessel 2 from solution sending tanks 4 and 5 at rates of 20 ml/min and 10 ml/min respectively. ICP composition analysis of the particles showed that Bi/Ti atomic ratio was 12.2. Further, SEM observation showed that the particles obtained were those with an average particle diameter of about 8 μm and a coefficient of variation of 30%.

### Comparative Example 3

Particles having Bi₁₂GeO₂₀ crystal structure were obtained in a manner similar to that of Comparative Example 2, except that the titanium tetraisopropoxide in additive solution “b” was substituted with equimolar germanium isopropoxide. ICP composition analysis of the particles showed that Bi/Ge atomic ratio was 11.9. Further, SEM observation showed that the particles obtained were those with an average particle diameter of about 15 μm and a coefficient of variation of 27%.

### (Manufacture of Photoconductive Layer)

50 ml of ethanol was added to 50 g of particles obtained in each of Examples 1 to 10 and Comparative Examples 1 to 3, then 0.4% polyvinyl butyral was further added as a binder, and the solution was dispersed lightly. Then, 3.7% polyvinyl butyral and 0.8 mass % dioctyl phthalate were added to the solution and the resultant solution was sufficiently mixed and dispersed using a planetary mixer, whereby slurry was obtained. The slurry obtained was coated on a film base having a mold release agent applied thereon to prepare a green sheet. The molded body was dried for 24 hours under room temperature and moved on a sapphire setter having good planarity. Then the molded body was heated up to 450° C. for 10 hours under ambient atmosphere to remove the binder, which is baked in a gas muffle furnace at 850° C. for two hours under argon gas flow, whereby a photoconductive layer with a thickness of 500 μm was obtained.

### (Evaluation Method and Evaluation Results)

Gold is deposited on each side of each of the photoconductive layers produced above with a thickness of 600 nm. While applying a voltage of 1 kV between the electrodes of each photoconductive layer, one millirem of X-rays were emitted from a medical radiation source for 0.1 seconds to measure the amounts of charges and dark current per unit dose from a generated X-ray photoelectric current. The measurement results are shown in Table 1 in relative ratios with respect to the measured values of Comparative Example 1. (A larger relative ratio is desirable for the amount of generated charges, and a smaller relative ratio is desirable for the amount of dark current.)

TABLE 1

| | | Coefficient | Charge | Dark |
|---|---|---|---|---|
| | BiMO | of Variation | Amount | Current |
| | Particles | (%) | (Re. Ratio) | (Re. Ratio) |
| Ex1 | Bi₁₂SiO₂₀ | 16 | 1.7 | 0.58 |
| Ex2 | Bi₁₂SiO₂₀ | 18 | 1.5 | 0.75 |
| Ex3 | Bi₁₂SiO₂₀ | 19 | 1.6 | 0.67 |
| Ex4 | Bi₁₂SiO₂₀ | 16 | 1.9 | 0.58 |
| Ex5 | Bi₁₂GeO₂₀ | 16 | 2.1 | 0.83 |
| Ex6 | Bi₁₂SiO₂₀ | 17 | 1.7 | 0.92 |
| Ex7 | Bi₁₂TiO₂₀ | 20 | 0.5 | 0.42 |
| Ex8 | Bi₁₂SnO₂₀ | 18 | 0.6 | 0.58 |
| Ex9 | Bi₁₂Ge_{0.6}Si_{0.4}O₂₀ | 19 | 1.9 | 0.75 |
| Ex10 | Bi₄Ge₃O₁₂ | 19 | 0.3 | 0.11 |
| Comp. | Bi₁₂SiO₂₀ | 28 | 1 | 1 |
| Ex1 | | | | |
| Comp. | Bi₁₂TiO₂₀ | 30 | 0.3 | 0.95 |
| Ex2 | | | | |
| Comp. | Bi₁₂GeO₂₀ | 27 | 1.1 | 1.00 |
| Ex3 | | | | |

As shown in Table 1, with respect to the BiMO particles of Examples 1 to 4 and 6, photoconductive layers capable of providing large amounts of charges and small mounts of dark current were produced in comparison with the BiMO particles of Comparative Example 1. Also, with respect to the particles having Bi₁₂GeO₂₀ structure of Example 5 and particles having structure of Example 7, photoconductive layers capable of providing large amounts of charges and small mounts of dark current were produced in comparison with the particles of Comparative Examples 3 and 2 respectively. Further, with respect to the particles of Example 10, a photoconductive layer capable of providing a large amount of charges and a small amount of dark current was produced. The results also show that the particles having crystal structures of Bi₁₂TiO₂₀, Bi₁₂SnO₂₀, and Bi₄Ge₃O₁₂ provide smaller amounts of charges in comparison with the particles having crystal structures of Bi₁₂SiO₂₀ and Bi₁₂GeO₂₀. It has been found out from the evaluation results that compounds having a Bi₁₂MO₂₀ (M is either Si or Ge) structure are preferably used as the particles for photoconductive layers.

### Example 11

47.8 g of bismuth citrate (99.99% purity) and 35.8 g of triethanolamine were dissolved in 360 ml of water. Then, 2.4 ml of potassium silicate solution (28%) was added to the water solution to prepare mother liquor (pH is about 7). The solution was then poured into reaction vessel 2 (stainless steel) of manufacturing equipment 1 having an agitator 1 shown in FIG. 1 of Patent Document 1. Reaction vessel 2 was heated by jacket 3 to raise the temperature of the solution to 85° C. The rotational speed of motor 9 is set to 800 r/min and the reaction solution was agitated by agitator 8. 200 ml of 4N—KOH solution was poured into solution sending tank 4 and the solution was added to reaction tank at a rate of 20 ml/min. Here, solution sending tank 5 was not used. After the addition, the resultant solution was agitated for five hours and then cooled to normal temperature. The white sediment obtained was filtered and refined. Particles obtained by drying the sediment were measured by X-ray diffraction method (XRD) and Bi₁₂SiO₂₀ crystals with Sillenite structure were obtained. Observation of the particles with a scanning electron microscope (SEM) showed that the particles obtained were cubic particles with an average particle diameter of about 5 μm and a coefficient of variation of 15%. The Composition analysis of the particles by ICP showed that the Bi/Si atomic ratio was 11.6 (particles A). Some of the particles A were baked for four hours at 300° C., for two hours at 500° C., for two hours at 650° C., and for one hour at 850° C. respectively to prepare particles B, particles C, and particles D.

### Example 12

Particles were obtained in a manner similar to that of Example 1, except that the potassium silicate solution and 4N—KOH were substituted with equimolar germanium oxide (IV) and tetramethylammonium hydroxide solution respectively, and reaction temperature was set to 80° C. XRD measurement of the particles showed Bi₁₂GeO₂₀ crystal structure was obtained. Composition analysis by ICP showed that the Bi/Ge atomic ratio was 12.0. Further, SEM observation showed that the particles are cubic particles with an average particle diameter of about 6 μm and a coefficient of variation of 17% (particles F). Some of the particles F were baked for two hours at 500° C. to prepare particles G.

Using the particles A, B, C, D, E, F, and G obtained in Examples 11 and 12, photoconductive layers were produced in the same manner as described above and evaluated in the same manner as described above. The evaluation results are shown in Table 2 below, in which the amounts of charges generated and dark current are shown in relative ratios with respect to measured values of Comparative Example 1.

TABLE 2

| | | | Charge | Dark |
|---|---|---|---|---|
| | BiMO | Baking | Amount | Current |
| | Particles | Conditions | (Re. Ratio) | (Re. Ratio) |
| Comp. Ex1 | Bi₁₂SiO₂₀ | Non | 1 | 1 |
| Particle A | Bi₁₂SiO₂₀ | Non | 1.6 | 0.86 |
| Particle B | Bi₁₂SiO₂₀ | 4 h at 300° C. | 1.6 | 0.76 |
| Particle C | Bi₁₂SiO₂₀ | 2 h at 500° C. | 1.9 | 0.30 |
| Particle D | Bi₁₂SiO₂₀ | 2 h at 650° C. | 1.9 | 0.28 |
| Particle E | Bi₁₂SiO₂₀ | 1 h at 850° C. | Not produced due | |
| | | | to sintered particles | |
| Particle F | Bi₁₂GeO₂₀ | Non | 2.1 | 0.52 |
| Particle G | Bi₁₂GeO₂₀ | 2 h at 500° C. | 2.3 | 0.10 |

As Table 2 clearly shows, the photoconductive layers produced by using particles C, D, and G which are BiMO particles further baked at 400 to 700° C. may provided increased amounts of charges with remarkably reduced dark current in comparison with photoconductive layers produced by using particles A and F. From the results, it has been found out that the further baking of obtained BiMO particles at 400 to 700° C. may facilitate removal of organic substances and crystallization, thereby improving the performance of a photoconductive layer to be produced. The photoconductive layer produced by using particles B baked at a temperature below 400° C. may reduce the dark current in comparison with a photoconductive layer produced by using unbaked particles A or particles of Comparative Example 1 manufactured by a method different from the method of the present invention, although the dark current reduction effect is not so great as that of the photoconductive layer produced by using particles C or D. A photoconductive layer was not produced with particles E because the particles were sintered during the baking step.

As described above, according to the manufacturing method of the present invention, a high concentration solution of water-soluble bismuth salt may be prepared by causing reaction in the presence of an amino compound. This allows particles having a remarkably stable size, shape, and composition to be easily manufactured in large amounts in comparison with conventional liquid phase methods. Then, the use of the particles having a Bi₁₂MO₂₀ (M is either Si or Ge) crystal structure obtained by the manufacturing method of the present invention to a photoconductive layer constituting a radiation imaging panel allows the photoconductive layer to have high collection efficiency of generated charges and reduced electrical noise, since the layer is formed with particles having stable size, shape, and composition, as described above. This results in improved granularity of an image and increased sensitivity. In addition, baking of the obtained BiMO particles at a predetermined temperature may facilitate removal of organic substances and crystallization, whereby a high sensitivity photoconductive layer may be manufactured.

What is claimed is:

1. A method for manufacturing a BiMO particle (M is either one of Si, Ge, Ti, and Sn), wherein at least one type of compound selected from the group consisting of a silicon compound, a germanium compound, a titanium compound, and a tin compound is reacted with a bismuth compound by agitating and mixing the compounds in an alkali water solution in the presence of an amino compound.

2. The method of claim 1, wherein the amino compound is a water-soluble aliphatic amino compound.

3. The method of claim 2, wherein the aliphatic amino compound is an alkanolamine.

4. The method of claim 1, wherein the alkali water solution further includes a multivalent organic acid or a salt thereof.

5. The method of claim 1, wherein the bismuth compound is a multivalent organic acid bismuth compound.

6. The method of claim 1, wherein the silicon compound is an alkali metal, quaternary ammonium silicate, or a tetraalkoxysilane.

7. The method of claim 1, wherein the germanium compound is a germanium oxide (IV) or a germanium tetraalkoxide.

8. The method of claim 1, wherein the titanium compound is a titanium chloride (IV) or a titanium (IV) tetraalkoxide.

9. The method of claim 1, wherein the alkali water solution is at least one water solution selected from the group consisting of an alkali metal hydroxide, an NR₄OH (R is an alkyl group with a carbon number 1 to 4), an amidine, and a guanidine.

10. The method of claim 1, wherein the temperature of the reaction is in the range from 40° C. to a boiling point of the alkali water solution.

11. A method for manufacturing a BiMO particle, wherein a BiMO particle manufactured by the method of claim 1 is further baked at a temperature in the range from 400 to 700° C.

12. A photoconductive layer constituting a radiation imaging panel for recording radiation image information as an electrostatic latent image, wherein the photoconductive layer is a layer manufactured by using a BiMO particle obtained by the method of claim 1.
